(19) United States
(12) Patent Application Publication
(10) Pub. No.: US 2019/0188201 A1
(43) Pub. Date: Jun. 20, 2019

(54) SYSTEMS AND METHODS FOR MOTIF DISCOVERY WITHIN TIME-SERIES DATA

(71) Applicant: TRENDALYZE, INC., NEWARK, NJ (US)

(72) Inventors: Radoslav Paraschkavov Kotorov, Somerset, NJ (US); Dave Watson, Mountnessing (GB)

(21) Appl. No.: 16/207,256

(22) Filed: Dec. 3, 2018

Related U.S. Application Data
(60) Provisional application No. 62/607,813, filed on Dec. 19, 2017.

(51) Int. Cl. G06F 16/2458; G06F 16/242; G06F 16/2457; G06F 16/248

(52) U.S. Cl. CPC G06F 16/2477; G06F 16/248; G06F 16/24578; G06F 16/242

(57) ABSTRACT

Systems and methods are provided for motif discovery in time-series data is provided. The method includes displaying the time-series data on an interactive line chart component, selecting a time sequence subset from the time-series data displayed on the interactive line chart, converting data points from the selected time sequence subset into query parameters, generating a search query against the time-series data to retrieve a set of time sequences matching the query parameters, generating a similarity score for each member of the set of time sequences to the time sequence subset, and displaying a motif on the interactive line chart formed by the time sequences with a similarity score satisfying a threshold condition.

### CLAIM OF PRIORITY

This application is a United States non-provisional application and claims priority to U.S. Provisional Patent Application No. 62/607,813, filed Dec. 19, 2017, herein incorporated by reference in its entirety.

### FIELD OF THE EMBODIMENTS

The present invention relates to the field of interactively querying data and more specifically to the field of time-series search and matching for repeating sequential patterns.

### BACKGROUND OF THE EMBODIMENTS

Discovering repeating patterns, called motifs, in time-series data is very beneficial as it enables hidden causal relationships to be uncovered that can facilitate drug discovery and disease treatment in healthcare, can facilitate the elimination of failures and inefficiencies in industrial and manufacturing processes, can enable the tracking of usage patterns in retail, energy consumption, and other industries to optimize services and resource utilization, fraud and abuse prevention in financial transactions, and early detection of security breaches, among others. Once motifs are discovered and understood, they can be used in monitoring applications that can scale to millions of users.

The benefits of time series pattern analysis have been known for a long time. Various statistical methods, such as seasonality analysis, have been developed to discover repeating patterns. However, these methods work for small data sets as they require enormous computational power. For example, querying a data set of 1000 data points to find matches for a selected sequential pattern of 15 data points requires the creation of 985 sequences, each sequence having 15 data points (1000-15), and comparing each one of the sequences to the original selection. While this is manageable for a data set of 1000 data points, it is not scalable for large data sets being created by industrial internet applications.

The emergence of the Internet of Things (IoT) allows for the collection of time series data at shorter frequencies. Embedded sensors can collect and transmit biometric- and machine-generated data at very small intervals. It is not unusual for sensors to capture and transmit data every second, resulting in 86,400 data points per day. This amount grows significantly if data is collected every millisecond, as it is in some medical applications. The numbers get even more daunting as we add the number of patients and devices that transmit data and that are analyzed and monitored continuously. These very large data sets hold the biggest promise for scientific discovery and optimization, and the present invention provides a method and a system that solves the problem of finding motifs in such large data sets.

### SUMMARY OF THE EMBODIMENTS

According to an aspect of the present invention, a method for motif discovery in time-series data is provided. The method includes displaying the time-series data on an interactive line chart component, selecting a time sequence subset from the time-series data displayed on the interactive line chart, converting data points from the selected time sequence subset into query parameters, generating a search query against the time-series data to retrieve a set of time sequences matching the query parameters, generating a similarity score for each member of the set of time sequences to the time sequence subset, and displaying a motif on the interactive line chart formed by the time sequences with a similarity score satisfying a threshold condition.

According to another aspect of the present invention, a computer based system for motif discovery in time-series data is provided. The computer based system includes a data store configured for ingestion and querying of disparate time-series data sets with diverse layout formats without conforming to a schema, a data services interface module configured to provide data connections to external data sources for data ingestion into the said data store, a server configured to process motif searches against the said data store and to pass results for display and analysis on user computer devices, the server further being configured to embed results in applications and monitoring devices, and a graphical user interface accessible on user computer devices for interactive visualization and exploration of time motifs.

According to yet another aspect of the present invention, a computer program product embodied in non-transitory computer-readable media carrying executable code is provided, wherein the code, when executed, produces a search query against a time-series data set to retrieve time sequences having similar characteristics to a pre-selected time sequence from within the time-series data set, and generates an interactive visualization displaying a time motif formed by the time sequences having similar characteristics to the pre-select tune sequences.

It is an object of the present invention to provide the method for motif discovery in time-series data, wherein the motif is visually distinguished from the time-series data set displayed on the interactive line chart component.

It is an object of the present invention to provide the method for motif discovery in time-series data, wherein a number of query parameters can be equal or less than the number of data points in the selected time sequence subset.

It is an object of the present invention to provide the method for motif discovery in time-series data, wherein the number of parameters to be used in the generated search query is algorithmically determined.

It is an object of the present invention to provide the method for motif discover in time-series data, wherein the number of parameters to be used in the generated search query is determined by a user.

It is an object of the present invention to provide the method for motif discovery in time-series data, wherein the selection of the time sequence subset can be made using predefined shapes or free form polygon drawing.

It is an object of the present invention to provide the method for motif discovery in time-series data, wherein the time sequences comprising the motif are normalized and stacked for comparison.

It is an object of the present invention to provide the method for motif discovery in time-series data, wherein the similarity score is algorithmically generated.

It is an object of the present invention to provide the method for motif discovery in time-series data, wherein the algorithm for generating a similarity score can be varied by a user or by another application.

It is an object of the present invention to provide the method for motif discovery in time-series data, wherein multiple algorithms can be applied to select a best fit score.

It is an object of the present invention to provide the method for motif discovery in time-series data, wherein a prediction is generated for an occurrence of a motif based on a distribution of time sequences fitting a particular motif profile.

It is an object of the present invention to provide the method for motif discovery in time-series data, wherein an alert is generated for the prediction.

It is an object of the present invention to provide the method for motif discovery in time-series data, wherein the time-series data is ingested in a data store.

It is an object of the present invention to provide the computer based system for motif discovery in time-series data, wherein data streams from Internet connected devices are ingested in the data store in real-time.

It is an object of the present invention to provide the computer based system for motif discovery in time-series data, wherein the said server monitors for occurrences of motifs and generates alerts.

It is an object of the present invention to provide the computer based system for motif discovery in time-series data, wherein the said server monitors for occurrences of motifs in external data stores and applications.

It is an object of the present invention to provide the computer based system for motif discovery in time-series data, wherein the said server generates predictions about a likelihood of occurrence of motifs.

It is an object of the present invention to provide the computer based system for motif discovery in time-series data, wherein the said graphical user interface is configured to pivot time sequences comprising the motif for comparative analysis.

It is an object of the present invention to provide the computer program product embodied in non-transitory computer-readable media carrying executable code, wherein the code when executed generates an interactive controls to navigate and explore the time motif.

It is an object of the present invention to provide the computer program product embodied in non-transitory computer-readable media carrying executable code, wherein the code when executed generates alerts for the occurrence of time motifs.

It is an object of the present invention to provide the computer program product embodied in non-transitory computer-readable media carrying executable code, wherein the code when executed generates predictions about the expected occurrence of time motifs.

### BRIEF DESCRIPTION OF THE DRAWINGS

FIG. 1A shows a display of time-series data on a computer device, according to an embodiment of the present invention.

FIG. 1B shows a selection of a particular sequential pattern, according to an embodiment of the present invention.

FIG. 1C shows a motif firmed by repeating matching patterns, according to an embodiment of the present invention.

FIG. 2A shows an identification of a starting point of a sequential pattern and its conversion to a parameter, according to an embodiment of the present invention.

FIG. 2B shows data points that match a parameter, according to an embodiment of the present invention.

FIG. 2C shows construction of sequences based on a parameter, according to an embodiment of the present invention.

FIG. 3A shows an illustration of a use of two parameters, according to an embodiment of the present invention.

FIG. 3B shows an illustration of an addition of a third parameter, according to an embodiment of the present invention.

FIG. 4 shows a high level overview of the system for motif discovery, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto. Additionally, any examples set forth in this specification are not intended to be limiting and merely set forth some of the many possible embodiments for the claimed invention. Among other things, the present invention may be embodied as methods or devices. Accordingly, the present invention may take the form of an entirely hardware embodiment, and entirely software embodiment, or an embodiment combining software and hardware aspects. The following detailed description is, therefore, not to be taken in a limiting sense.

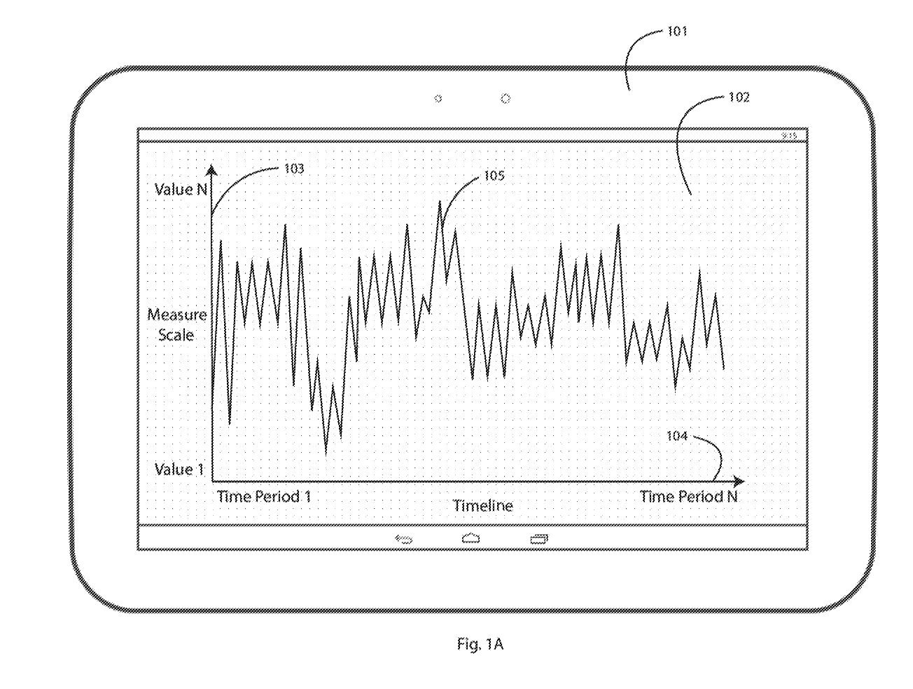

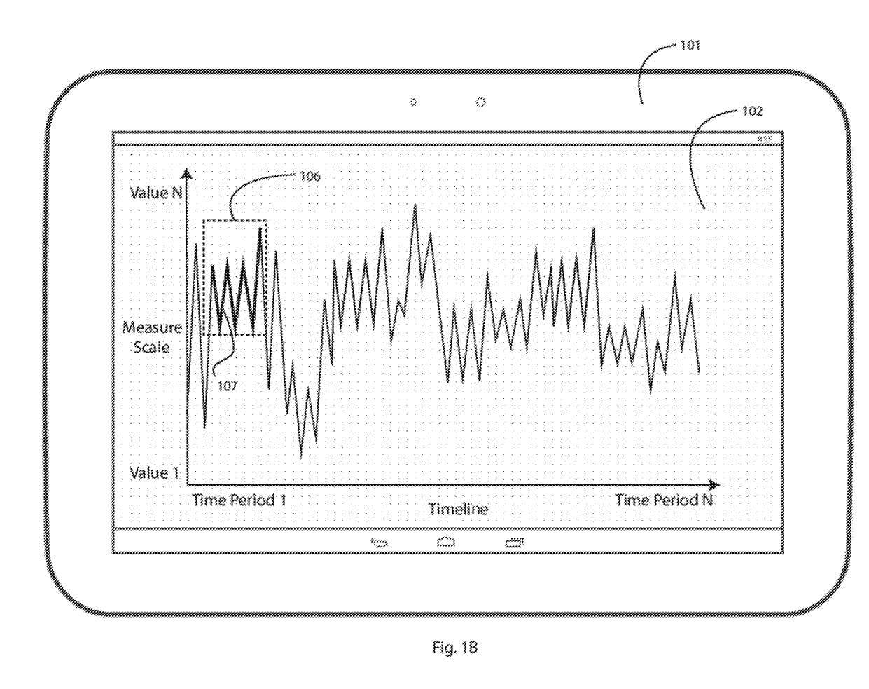

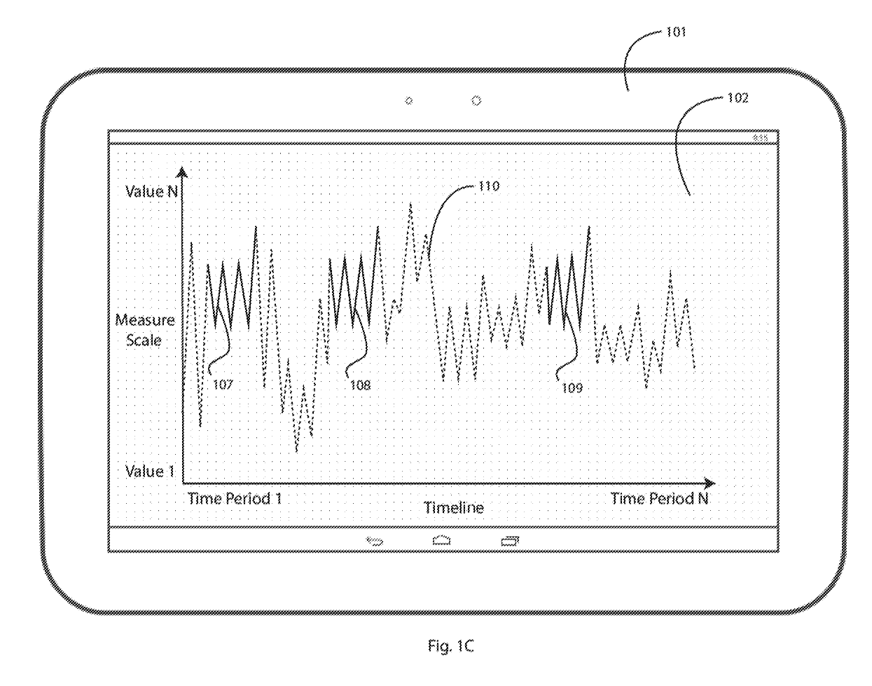

Retelling now to FIG. 1A, an illustration of a display of time-series data on a screen 102 of a computing device 101 is illustratively depicted, in accordance with an embodiment of the present invention.

The computing device 101 may be a personal computer, a laptop, a tablet, a mobile computing device (such as, e.g., a smart phone), or any other suitable computing device. Each point on the time-series line 105 is construed by a measure value mapped to axis 103 (labeled, in FIG. 1A, as “Measure Scale”) and a time stamp value mapped to axis 104 (labeled in FIG. 1A, as “Timeline”). It is clear from at least the complexity shown in the graph in FIG. 1A that it is difficult for a human eye to detect repeating patterns dense time-series data.

Referring now to FIG. 1B an interactive selection 106 of a particular pattern of interest 107 on screen 102 of computing device 101 is illustratively depicted, in accordance with an embodiment of the present invention.

According to an embodiment, the interactive selection 106 can be made by using a mouse device, a touch or pen screen technology, a combination of key strokes, or any other suitable computer selection method. This particular example shows a rectangular selection, but, for those skillful in the art, it will be immediately obvious that other shapes and/or polygon selections are possible.

Furthermore, according to an embodiment, a selection can be made by using a dialog where users can enter or adjust the time pattern parameters. As shown in FIG. 1B, the selected pattern 107 is highlighted to stand out from the rest of the time-series data. Various methods exist to make the selected pattern distinct from the rest of the time-series, such as highlighting, color coding, using dashed lines, setting various degrees of transparency, etc.

Referring now to FIG. 1C, a time motif formed by repeating time sequences 107, 108 and 109 is illustratively depicted, in accordance with an embodiment of the present invention. The time-series line 110 is visually de-emphasized by using a dashed line to make the motif stand out. For those skillful in the art it will become immediately obvious that there are other visual methods to make the motif stand out from the entire time-series. Comparing FIGS. 1A and 1C shows the cognitive value of motif discovery.

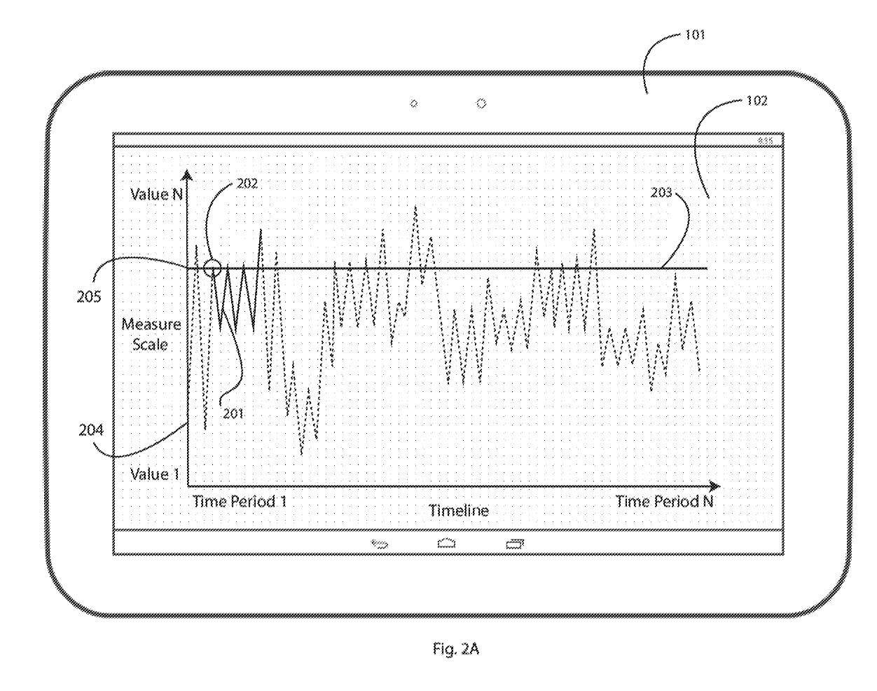

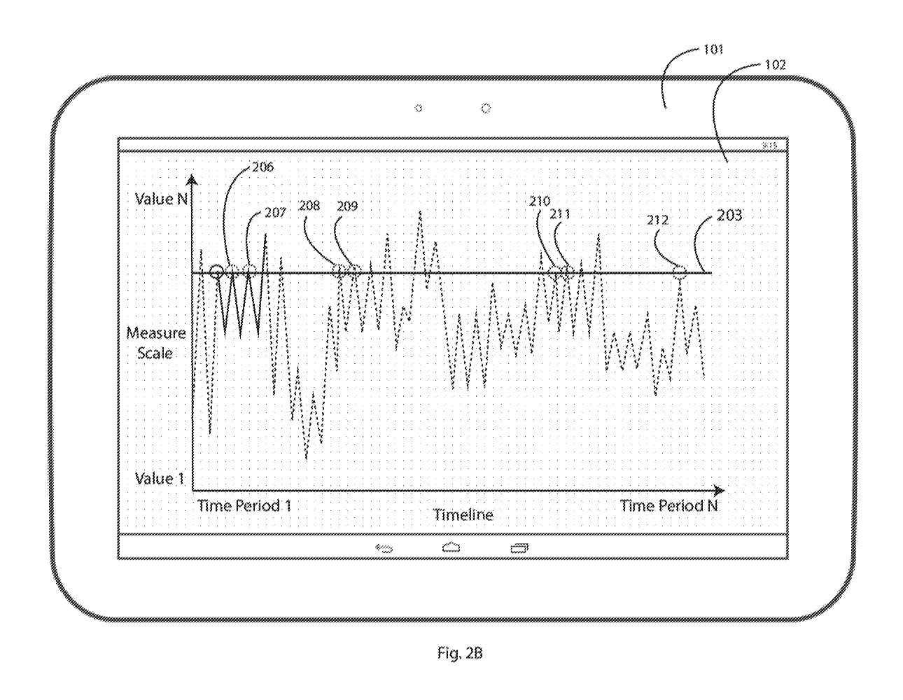

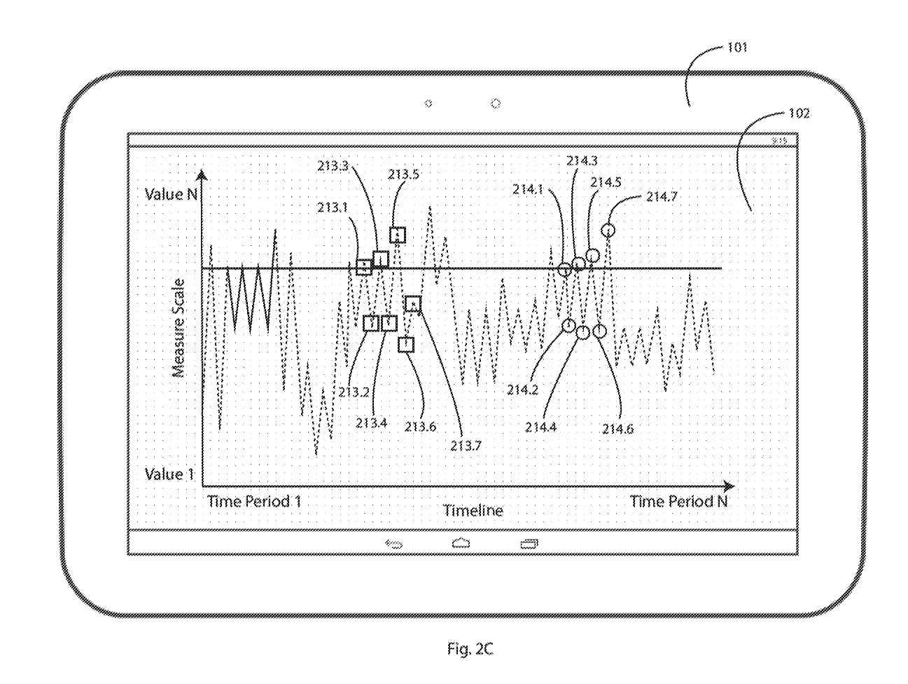

Referring now to FIG. 2A, the identification of the first data point 202 in selected sequential pattern 201 is illustratively depicted, in accordance with an embodiment of the present invention.

According to an embodiment, data point 202 is converted to a parameter that is used to query and identify data points in the time-series data set with similar measure values. Reference line 203 intersects the Y axis 204 at value point 205 which is the measurement value of the first data point 202.

According to an embodiment, all data points in the time-series data set that lie on or near the reference line 203 can be used to create new time sequences for matching. For those skillful in the art it will become obvious that upper and lower bounds can be set for the reference line, i.e., ±X % of value point 205.

Referring now to FIG. 2B, points 206, 207, 208, 209, 210, 211, and 212, that lie on or nearby reference line 203, that was set in FIG. 2A, are illustratively depicted, in accordance with an embodiment of the present invention.

As shown in FIG. 2B, point 208 is above reference line 203, indicating that the user may have set up some tolerance range around reference line 203. FIG. 2B further shows that there are only 7 candidates for constructing data sequences for matching which significant reduction from the total number of possible sequences.

Referring now to FIG. 2C, the construction of two data sequences based on parameter 202 from FIG. 2A is illustratively depicted, in accordance with an embodiment of the present invention.

The construction of the sequences involves two steps. First identify the starting points 213.1 and 214.1 that match the value of the parameter 202 from FIG. 2A, and, second identify the length of each sequence (213.2, 213.3, 213.4, 213.5, 213.6, and 213.7) and (214.2, 214.3, 214.4, 214.5, 214.6, and 214.7) to match the length of the selected sequential pattern 201 from FIG. 2A.

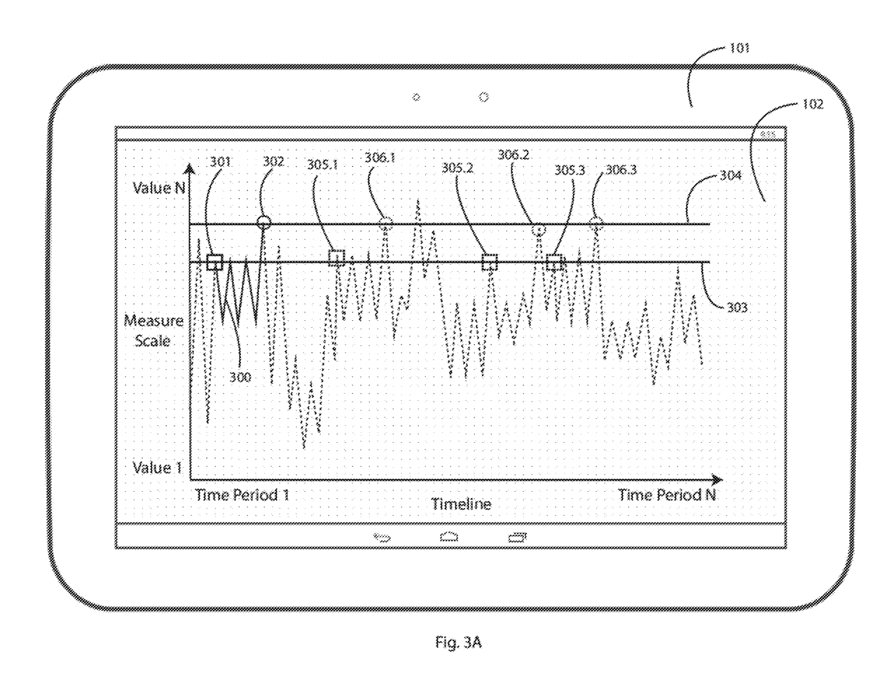

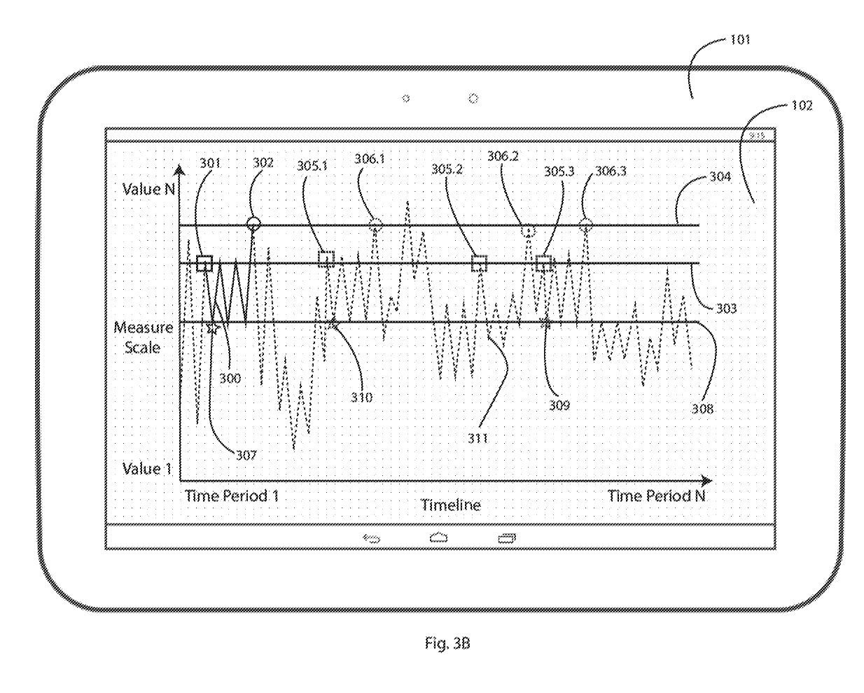

Referring now to FIG. 3A, a selected sequential pattern 300 where the starting data point 301 and ending data point 302 are converted to parameters is illustratively depicted, in accordance with an embodiment of the present invention.

Two corresponding reference lines 303 and 304 illustrate the identification of data points within the time-series data set that match the two parameters. Data points 305.1, 305.2 and 305.3 match parameter 301. Data points 306.1, 306.2 and 306.3 match parameter 302.

Referring now to FIG. 3B, an illustration of how the addition of a third parameter 307 further reduces the number of possible time sequences for matching is illustratively shown, in accordance with an embodiment of the present invention.

Before the addition of the third parameter 307, there were three time sequences that matched the first two parameters (sequence (305.1; 306.1), sequence (305.2; 306.2), and sequence (305.3; 306.3)). When a third reference line 308 is added based on data point 308, it can be seen that that data points 309 and 310 are on it but data point 311 is not. This eliminates sequence (305.2; 306.2) as a candidate for matching.

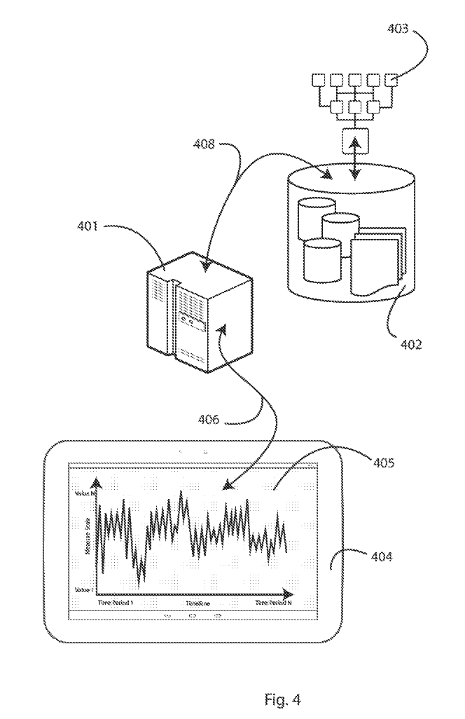

Referring now to FIG. 4, system components are illustratively depicted, in accordance with an embodiment of the present invention.

According to an embodiment, the system includes a remote web-based server 401 that processes user commands and queries. The server receives user commands and queries via an application programming interface 407. The user commands and queries are generated via graphical user interface 404 on a computer device 405. The server 401 sends queries and retrieves data from a data store 402 via a data services interface 408. Data is ingested into the store via an external data sources interface 406.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions in, be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and intemperate with one another.

The present invention may be based on computer systems that may comprise, but are not hunted to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemization, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of napping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”) and/or the like embedded technology. For example, any of the component collection (distributed or otherwise) and/or features of the present invention may be implemented via the microprocessor and/or via embedded components; e.g., via ASIC, coprocessor, DSP, FPGA and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like, data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g. still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc. may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also he used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client :component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The :operating system may be a highly hull tolerant, scalable, and secure system such as: Apple Macintosh OS X (Server); AT&T Plan 9; Be OS Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP), HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126./myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along, with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain communicate, generate, obtain, and/or provide program component, system, user and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number_of_beverages, current_beverage_temperature, current_ambient_temperature, and/or the like. A Parameter table may include fields including the foregoing fields, or additional ones such as cool_start_time, cool_preset, cooling_rate, and/or the like. A Cool Routines table may include a plurality of cooling sequences may include fields such as, but not limited to: sequence_type, sequence_id, flow_rate, avg_water_temp, cooling_time, pump_setting, pump_speed, pump_pressure, power_level, temperature_sensor_id_number, temperature_sensor_location, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for motif discovery in time-series data, comprising:
displaying the time-series data on an interactive line chart component;
selecting a time sequence subset from the time-series data displayed on the interactive line chart;
converting data points from the selected time sequence subset into query parameters;
generating a search query against the time-series data to retrieve a set of time sequences matching the query parameters;
generating a similarity score for each member of the set of time sequences to the time sequence subset; and
displaying a motif on the interactive line chart formed by the time sequences with a similarity score satisfying a threshold condition.

2. The method of claim 1 wherein the motif is visually distinguished from the time-series data set displayed on the interactive line chart component.

3. The method of claim 1 wherein a number of query parameters can be equal or less than the number of data points in the selected time sequence subset.

4. The method of claim 3 wherein the number of parameters to be used in the generated search query is algorithmically determined.

5. The method of claim 3 wherein the number of parameters to be used in the generated search query is determined by a user.

6. The method of claim 1 wherein the selection of the time sequence subset can be made using predefined shapes or free form polygon drawing.

7. The method of claim 1 wherein the time sequences comprising the motif are normalized and stacked for comparison.

8. The method of claim 1 wherein the similarity score is algorithmically generated.

9. The method of claim 8 wherein the algorithm for generating a similarity score can be varied by a user or by another application.

10. The method of claim 8 wherein multiple algorithms can be applied to select a best fit score.

11. The method of claim 1 wherein a prediction is generated for an occurrence of a motif based on a distribution of time sequences fitting a particular motif profile.

12. The method of claim 11 wherein an alert is generated for the prediction.

13. The method of claim 1 wherein the time-series data is ingested in a data store.

14. A computer based system for motif discovery in time-series data, comprising:
a data store configured for ingestion and querying of disparate time-series data sets with diverse layout formats without conforming to a schema;
a data services interface module configured to provide data connections to external data sources for data ingestion into the said data store;
a server configured to process motif searches against the said data store and to pass results for display and analysis on user computer devices;
the server further being configured to embed results in applications and monitoring devices; and
a graphical user interface accessible on user computer devices for interactive visualization and exploration of time motifs.

15. The computer based system from claim 14 wherein data streams from internet connected devices are ingested in the data store in real-time.

16. The computer based system of claim 14 wherein the said server monitors for occurrences of motifs and generates alerts.

17. The computer based system of claim 14 wherein the said server monitors for occurrences of motifs in external data stores and applications.

18. The computer based system of claim 14 wherein the said server generates predictions about a likelihood of occurrence of motifs.

19. The computer base system of claim 14 wherein the said graphical user interface is configured to pivot time sequences comprising the motif for comparative analysis.

20. A computer program product embodied in non-transitory computer-readable media carrying executable code, which code when executed:
produces a search query against a time-series data set to retrieve time sequences having similar characteristics to a pre-selected time sequence from within the time-series data set; and
generates an interactive visualization displaying a time motif formed by the time sequences having similar characteristics to the pre-select time sequences.

21. The computer program product of claim 20, wherein the code when executed generates an interactive controls to navigate and explore the time motif.

22. The computer program product of claim 20, wherein the code when executed generates alerts for the occurrence of time motifs.

23. The computer program product of claim 20, wherein the code when executed generates predictions about the expected occurrence of time motifs.
